(19) United States
(12) Patent Application Publication
(10) Pub. No.: US 2026/0169866 A1
(43) Pub. Date: Jun. 18, 2026

(54) FAULT TOLERANT CHECKPOINTING IN A DISTRIBUTED CACHE SYSTEM

(71) Applicant: Dell Products L.P., Round Rock, TX (US)

(72) Inventors: Qi Bao, Acton, MA (US); Emine Ugur Kaynar Terzioglu, Boston, MA (US); Gaurav Chawla, Austin, TX (US)

(21) Appl. No.: 18/979,281

(22) Filed: Dec. 12, 2024

(51) Int. Cl. G06F 11/14

(52) U.S. Cl. CPC G06F 11/1469; G06F 11/1451; G06F 11/1464

(57) ABSTRACT

The technologies described herein are generally directed toward storing fault tolerant checkpoint data in a distributed cache system. For instance, a system can divide a machine learning model into data chunks. Further, the system may, based on a number of nodes of a distributed model cache and the data chunks, generate recovery data corresponding to the data chunks. The system may further store the recovery data and a portion of the data chunks at selected nodes of the distributed model cache. The system may further, based on a storage failure in a node of the distributed model cache, recover based on data chunks not impacted by the storage failure and the recovery data, data chunks that were impacted by the storage failure.

### BACKGROUND

Modern systems that implement artificial intelligence (AI)/machine learning (ML) systems may manage multiple storage intensive operations. To improve fault tolerance, training workflows periodically save their model states for various reasons, such as handling failures, debugging models, or development purposes. In some circumstances, checkpointing operations may require the pausing of model training until the checkpoint is fully completed.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include dividing, by a system comprising a processor, a machine learning model into data chunks. Further, the example method may include, based on a number of nodes of a distributed model cache and the data chunks, generating, by the system, recovery data corresponding to the data chunks. The example method may include storing, by the system, the recovery data and a portion of the data chunks at selected nodes of the distributed model cache. The example method may further include, based on a storage failure in a node of the distributed model cache, recovering data chunks that were impacted by the storage failure, with the recovering being based on data chunks that were not impacted by the storage failure and the recovery data.

In additional or alternative embodiments, the system includes a model training system working in parallel with another model training system configured to store another portion of the data chunks at the distributed model cache. In additional or alternative embodiments, the portion of the data chunks and the other portion of the data chunks, in combination, comprise all of the data chunks of the machine learning model. In additional or alternative embodiments, the portion and the other portion were selected by a coordination between the model training system and the other model training system. In additional or alternative embodiments, a completion of the storing of the data chunks and the recovery data by the model training system and the other model training system includes completion of a checkpoint operation for the machine learning model.

In additional or alternative embodiments, the machine learning model corresponds to a synchronized machine learning model that was synchronized between the model training system and the other model training system before the dividing of the machine learning model. In additional or alternative embodiments, the model training system includes a training compute device that trained the machine learning model before the synchronizing of the machine learning model. In additional or alternative embodiments, the method further comprises, receiving, by the system, an indication of a completion of the storing of the recovery data and the data chunks at the selected nodes of the distributed model cache, and based on the indication, restarting, by the system, training of the machine learning model. In additional or alternative embodiments, the recovery data includes recovery data generated in accordance with a fault-tolerance protocol. In additional or alternative embodiments, the fault-tolerance protocol includes an erasure coding protocol. In additional or alternative embodiments, the number of nodes of the distributed model cache was selected based on the fault-tolerance protocol.

An example system can operate as follows. At least one memory may store computer executable instructions, and at least one processor may be configured to process the computer executable instructions that, when executed by the at least one processor, facilitate performance of operations. The operations may include communicating, to the first model training engine and the second model training engine, a number of data blocks to use for segmentation of an artificial intelligence model stored at the first model training engine and the second model training engine. The operations may further include, allocating, from the number of data blocks, caching of a first portion of the data blocks to the first model training engine, and a second portion of the data blocks to the second model training engine. The operations may further include receiving, respectively from the first model training engine and the second model training engine, a first indication that the allocated caching has been completed, and a second indication that recovery data generated based on the data blocks has been cached.

In additional or alternative embodiments, the operations may further include receiving, from a requesting system, a request for recovery of the data blocks based on an unreadable data block of the data blocks, and based on recoverable ones of the data blocks and the recovery data, generating a replacement data block to replace the unreadable data block. In additional or alternative embodiments, the operations may further include communicating the replacement data block to the requesting system. In additional or alternative embodiments, the artificial intelligence model includes a synchronized artificial intelligence model generated by combining a first working model trained by the first model training engine with a second working model trained by the second model training engine.

In additional or alternative embodiments, the operations may further include, identifying that the first model training engine has a performance characteristic that differs from the performance characteristic of the second model training engine, and based on the identifying, determining a first size of the first portion that differs from a second size of the second portion, wherein the first size was selected to reduce an inefficiency predicted to be caused by the performance characteristic. In additional or alternative embodiments, the performance characteristic includes a time to complete the caching of the respective first portion and second portion, and wherein, the determining of the first size includes determining the first size so as to reduce performance differences between the first model training engine and the second model training engine. In additional or alternative embodiments, the first portion and the second portion are cached to a distributed data cache. In additional or alternative embodiments, the operations further include receiving, from the distributed data cache, an indication that the data chunks have been further stored in a persistent storage device.

An example non-transitory machine-readable medium may include executable instructions that, when executed by at least one processor, facilitate performance of operations. The operations may include segmenting a predictive model into data shards, wherein the predictive model includes synchronized model that has been synchronized among a cluster of graphics processing unit servers that includes the graphics processing unit server. The operations may further comprise, based on the data shards, generating a parity shard configured to facilitate recovery of the data shards when a failed data shards of the data shards is not usable. Further, the operations may comprise, based on a checkpoint operation performed on the predictive model, receiving, from a cache controller system, an indication of a data shard of the data shards to copy to a caching node of a distributed data cache, wherein the parity shard is generated further based on a number of nodes comprised in the distributed data cache. The operations may further comprise, receiving, from the cache controller system, an instruction to restart training of the predictive model using training data.

In additional or alternative embodiments, the instruction was received based on a completion of the checkpoint operation to the distributed data cache by the graphics processing unit servers of the graphics processing unit cluster. In additional or alternative embodiments, the operations further include, receiving, from the cache controller system, a recovered version of the predictive model at a state that was subject to the checkpoint operation, and in additional or alternative embodiments, the recovered version of the predictive model was recovered based on the parity shard.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate storing fault tolerant checkpoint data in a distributed cache system, in accordance with one or more embodiments.

FIG. 2 is an architecture diagram of an example system that can facilitate storing fault tolerant checkpoint data in a distributed cache system, in accordance with one or more embodiments.

FIG. 3 is an architecture diagram of an example system that can facilitate storing fault tolerant checkpoint data in a distributed cache system, in accordance with one or more embodiments.

FIG. 4 is an architecture diagram of an example system that can facilitate storing fault tolerant checkpoint data in a distributed cache system, in accordance with one or more embodiments.

FIG. 5 is an architecture diagram of an example system 500 that can facilitate persisting the checkpoint data stored in the distributed cache system, in accordance with one or more embodiments.

FIG. 6 depicts a flow diagram representing example operations of an example method that can facilitate storing fault tolerant checkpoint data in a distributed cache system, in accordance with one or more embodiments.

FIG. 7 depicts an example system that can facilitate storing fault tolerant checkpoint data in a distributed cache system, in accordance with one or more embodiments.

FIG. 8 depicts an example non-transitory machine-readable medium that can include executable instructions that, when executed by a processor of a system, can facilitate storing fault tolerant checkpoint data in a distributed cache system, in accordance with one or more embodiments.

FIG. 9 depicts an example schematic block diagram of a computing environment with which the disclosed subject matter can interact.

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance of a computing system that implements and/or otherwise interacts with an LLM or other similar machine learning model can be improved, e.g., by reducing latency and performance losses that can occur when checkpointing or restoring increasingly large machine learning models that are trained by multiple compute processors simultaneously. Further, it is noted that implementations described herein can provide solutions to technical problems that are inextricably tied to computer systems. For example, approaches that may reduce latency and performance losses in the checkpointing process may cause reductions in fault tolerance beyond acceptable levels. As described below, embodiments described herein utilize approaches that solve these and other technical problems with technical solutions. Moreover, implementations described herein can provide solutions to technical problems that are inextricably tied to computer systems, and provide these solutions in a manner that cannot reliably be performed by a human or even a plurality of humans, e.g., analyzing multiple versions of a complex large language models to generate recovery data, allocate processing of data chunks in real-time so as to improve overall performance without compromising other considerations.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

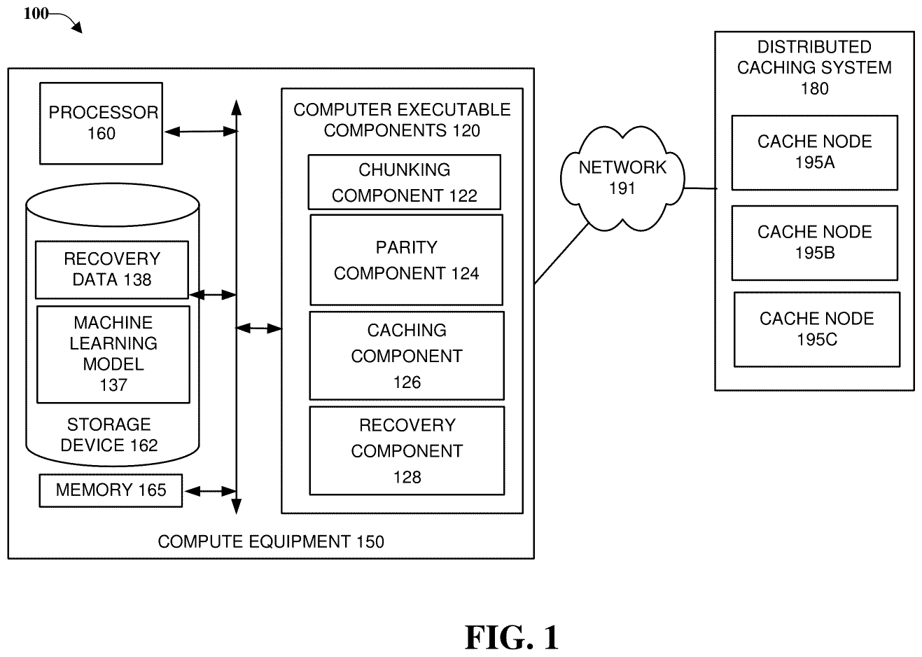

FIG. 1 is an architecture diagram of an example system 100 that can facilitate storing fault tolerant checkpoint data in a distributed cache system, in accordance with one or more embodiments. For purposes of brevity, description of like elements and/or processes employed in other embodiments is omitted. As depicted, system 100 includes compute equipment 150 connected, via network 191, to distributed caching system 180. Distributed caching system 180 includes cache nodes 195A-C.

As depicted, compute equipment 150 can include memory 165 that can store one or more computer and/or machine readable, writable, and/or executable components 120 and/or instructions. In embodiments, compute equipment 150 can further include processor 160. In one or more embodiments, computer executable components 120, when executed by processor 160, can facilitate performance of operations defined by the executable component(s) and/or instruction(s). Computer executable components 120 can include chunking component 122, parity component 124, caching component 126, recovery component 128, and other components described or suggested by different embodiments described herein, that can improve the operation of system 100. Compute equipment 150 may further include storage device 162. In an example, storage device 162 may provide nonvolatile storage of data, data structures, computer executable instructions, and so forth. Storage device 162 is depicted as storing recovery data 138 and machine learning model 137, e.g., trained by compute processors of compute equipment 150 (not shown).

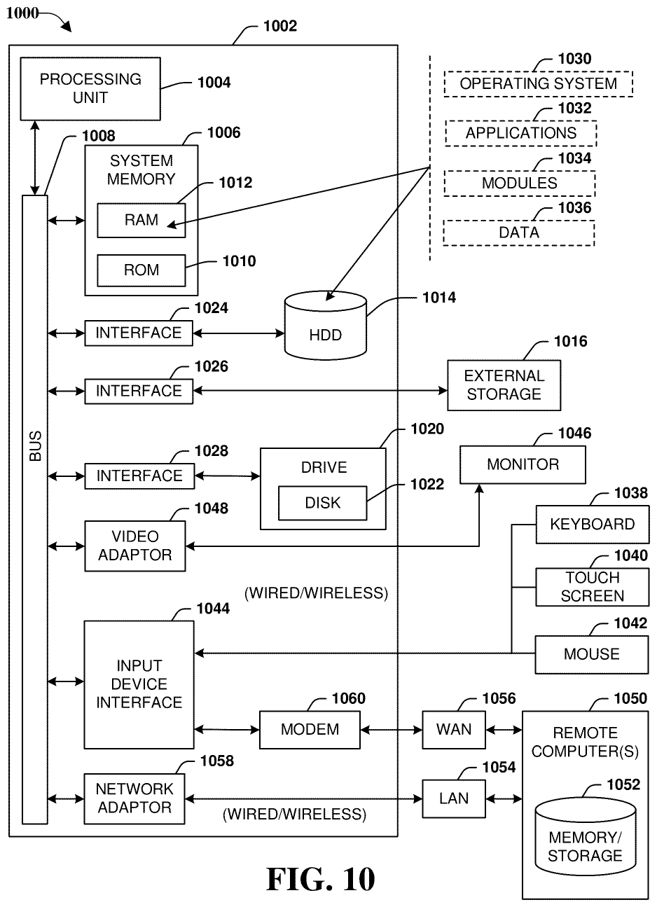

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

As discussed further with FIG. 10 below, network 191 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2(3GPP2 ) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of chunking component 122, which can in some implementations, divide a machine learning model into data chunks. For example, chunking component 122 can divide a machine learning model 137 into data chunks.

Regarding data chunks generally, in one or more embodiments described herein, model data may be described as being subject to dividing, chunking, segmentation, sharding, splitting, partitioning, or other similar separating terms, e.g., when the data is divided into smaller, more manageable data chunks. Including embodiments described with FIGS. 1-5, one or more embodiments may generate data chunks to facilitate operations including, parallel processing, improving efficiency of data storage, improve the efficiency of data transmission across a network, and/or other purposes.

In another example, memory 165 can store executable instructions that can facilitate generation of parity component 124, which in some implementations may, based on a number of nodes of a distributed model cache and the data chunks, generate recovery data corresponding to the data chunks. For example, parity component 124, can generate recovery data 138 based on the three nodes 195A-C of distributed caching system 180 and the data chunks generated by chunking component 122.

Regarding parity component 124 and other similar elements described herein, operations described that involve storing primary data (e.g., data chunks corresponding to machine learning model data) and supplementary recovery data (e.g., recovery data, parity chunks, parity shards) across multiple nodes, involve approaches that use one or more protocols that include, data redundancy, redundant encoding, parity data, erasure encoded data, and/or other approaches that facilitate fault tolerance and data recovery. It is to be appreciated that, for convenience, some examples of the use of recovery data described herein simplify the conditions under which some recovery data approaches are generally (or required to be) implemented. An example of this simplification involves the example number of nodes used to store the data chunks and recovery data described in the example. One having skill in the relevant art(s), given the description herein appreciate the different node configurations that may be used (or required to be used) with different embodiments.

In another example, memory 165 can store executable instructions that can facilitate generation of caching component 126, which in some implementations may store recovery data and a portion of the data chunks at selected nodes of the distributed model cache. For example, caching component 126 may store recovery data 138 and a portion of the data chunks at selected cache nodes 195A-B of distributed caching system 180.

In another example, memory 165 can store executable instructions that can facilitate generation of recovery component 128, which in some implementations may, based on a storage failure in a node of the distributed model cache, recover data chunks that were impacted by the storage failure, with the recovering being based on data chunks that were not impacted by the storage failure and the recovery data. For example, recovery component 128 may, based on a storage failure of cache node 195A, and employing the data chunks stored in cache node 195B-C and recovery data 138, recover data chunks stored to failed cache node 195A.

It is appreciated that the embodiments of the subject disclosure depicted in various figures disclosed herein are for illustration only, and as such, the architecture of such embodiments are not limited to the systems, devices, and/or components depicted therein. For example, in some embodiments, compute equipment 150, distributed caching system 180, and other devices discussed herein, can further comprise various computer and/or computing-based elements described herein with reference to operating environment 1000 and FIG. 10. In one or more embodiments, such computer and/or computing-based elements can be used in connection with implementing one or more of the systems, devices, components, and/or computer-implemented operations shown and described in connection with FIG. 1 or other figures disclosed herein.

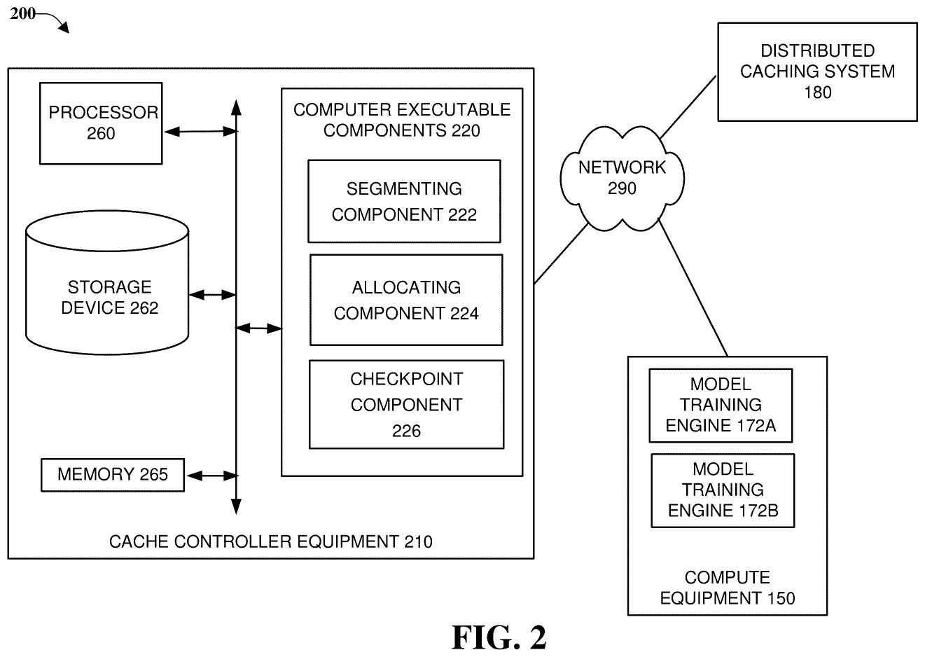

It should be noted that compute equipment 150, distributed caching system 180, cache controller equipment described with FIG. 2, and other devices discussed herein, can execute code instructions that may operate on servers or systems, remote data centers, or ‘on-box’ in individual client information handling systems, according to various embodiments described herein. In some embodiments, it is understood any or all implementations of one or more embodiments described herein can operate on a plurality of computers, collectively referred to as compute equipment 150. For example, one or more of compute equipment 150, and distribute caching system 180 can all be separate subsystems running in the kernel of a computing device as well as operating on separate network equipment, e.g., as depicted in FIGS. 1 and 2.

FIG. 2 is an architecture diagram of an example system 200 that can facilitate storing fault tolerant checkpoint data in a distributed cache system, in accordance with one or more embodiments. For purposes of brevity, description of like elements and/or processes employed in other embodiments is omitted. As depicted, system 200 includes cache controller equipment 210 connected, via network 290, to compute equipment 150 and distributed caching system 180. Cache controller equipment 210 includes processor 260, memory 265, storage device 262, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include segmenting component 222, allocating component 224, and checkpoint component 226, and other components described or suggested by different embodiments described herein, e.g., that can improve the operation of system 200, in accordance with one or more embodiments.

In an example implementation of cache controller equipment 210, memory 265 can store executable instructions that can facilitate generation of segmenting component 222, which in some implementations, may communicate, to the first model training engine and the second model training engine, a number of data blocks to use for segmentation of an artificial intelligence model stored at the first model training engine and the second model training engine communicate, to the first model training engine and the second model training engine, a number of data blocks to use for segmentation of an artificial intelligence model stored at the first model training engine and the second model training engine. For example, segmenting component 222, may communicate, to compute equipment 150 and another model training engine (not shown), a number of data blocks to use for segmentation of machine learning model 137 stored at compute equipment 150.

In an example implementation of distributed caching system 180, memory 265 can further store executable instructions that can facilitate generation of allocating component 224, which in some implementations, may allocate, from the number of data blocks, caching of a first portion of the data blocks to the first model training engine, and a second portion of the data blocks to the second model training engine. For example, allocating component 224 may allocate, from the number of data blocks, caching of a first portion of the data blocks to the first model training engine, and a second portion of the data blocks to the second model training engine.

In an example implementation of distributed caching system 180, memory 265 can further store executable instructions that can facilitate generation of checkpointing component 226, which in some implementations, may receive, respectively from the first model training engine and the second model training engine, a first indication that the allocated caching has been completed, and a second indication that recovery data generated based on the data blocks has been cached.

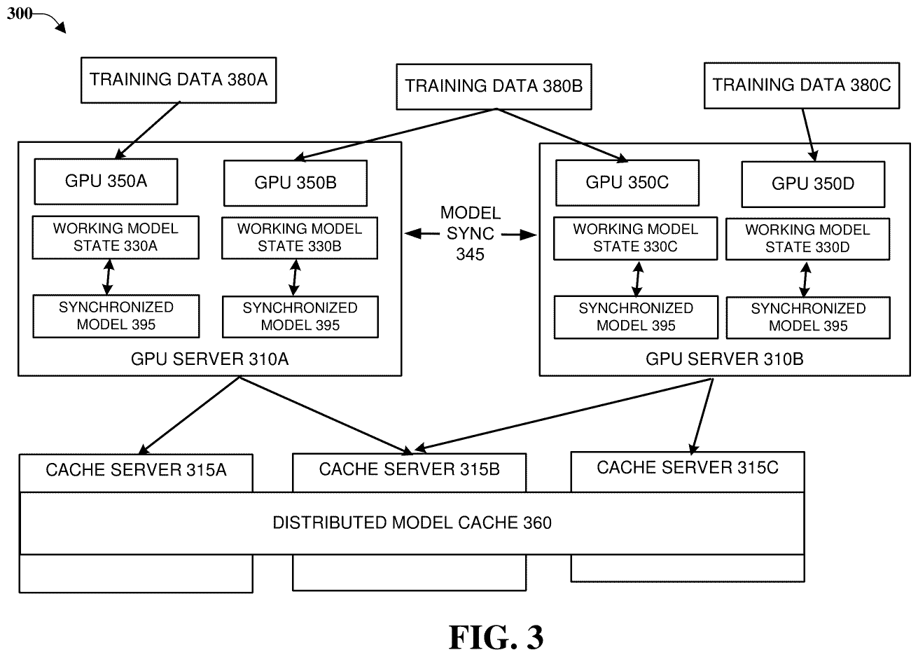

FIG. 3 is an architecture diagram of an example system 300 that can facilitate storing fault tolerant checkpoint data in a distributed cache system, in accordance with one or more embodiments. For purposes of brevity, description of like elements and/or processes employed in other embodiments is omitted. As depicted, system 300 includes graphics processing unit (GPU) servers 310A-B receiving various training data 380A-C, and coupled to cache servers 315A-C. GPU servers 310A-B respectively include GPUs 350A-B and 350C-D, working model states 330A-B and 330C-D, and instances of synchronized model 395. Cache servers 315A-C jointly implement distributed model cache 360.

It is appreciated the components included in FIGS. 1-5 are provided for illustration of concepts described with embodiments herein. As such, and number of components may be included to illustrate concepts, e.g., although FIG. 3 depicts only two GPE servers 310A-B with collectively four GPUs 350A-D, is it understood that in deployment of the concepts described herein, may more of these elements would likely be used.

In one or more embodiments, GPU servers 310A-B are tasked with processing an epoch with training data 380A-C being processed. GPUs 350A-D will perform in parallel, computations including, but not limited to, forward propagation, loss calculation, backpropagation, and weight updating, for training data 380A-C in the epoch. GPUs 350A and GPU 350C will process training data 380A and 380C, respectively, and training data 380B will be processed by GPUs 350B-C, e.g., differentially processing the training data 380B with variations in configuration and/or differences based on random number seeding.

In an implementation, GPUs 350A-D begin processing synchronized model 395, with the synchronization having been performed between GPU servers 310A-B. As GPUs 350A-D proceed to variously process training data 380A-C, due to weight updates and other processes, the originally synchronized model 395 at GPUs 350A-D changes to have respective working model states 330A-D, respectively.

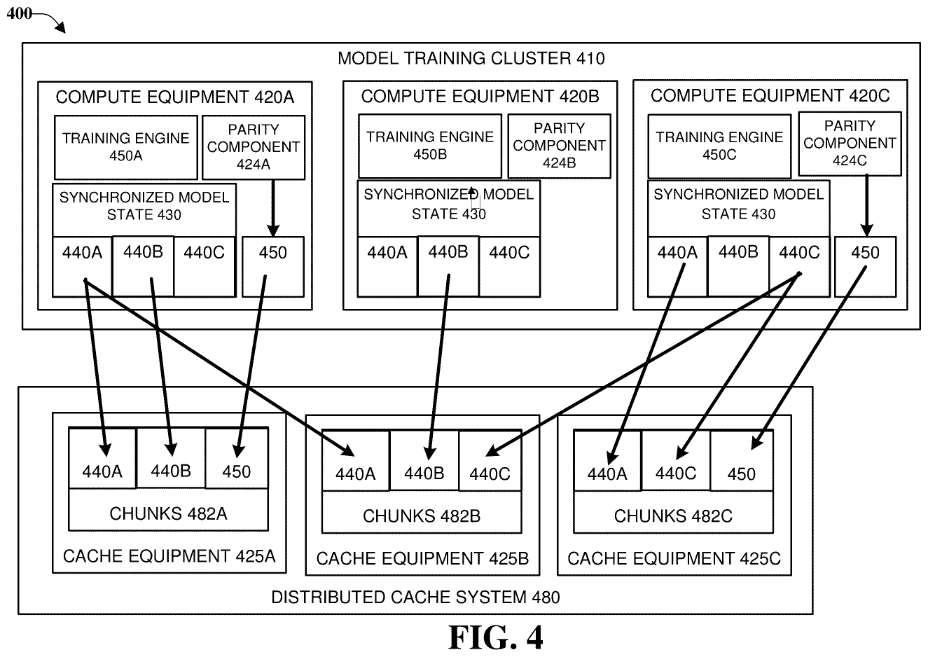

In one or more embodiments, at different intervals, a checkpoint may be performed whereby synchronized model 395 is duplicated to act as a backup, e.g., in case of a storage failure during the epoch. In an example where one or both of GPU servers 310A-B perform this checkpoint operation on synchronized model 395, training could not be restarted until one or both of GPU servers 310A-B complete copying the potentially very large, synchronized model. This is an example of inefficiencies caused by bottleneck operations that one or more embodiments may reduce. In an alternate example described in detail with FIG. 4 below, one or more embodiments may perform the checkpoint by using a combination of data chunking, and a distributed data cache system that uses parallel processing performed by multiple computer systems.

FIG. 4 is an architecture diagram of an example system 400 that can facilitate storing fault tolerant checkpoint data in a distributed cache system, in accordance with one or more embodiments. For purposes of brevity, description of like elements and/or processes employed in other embodiments is omitted. As depicted, system 400 includes model training cluster 410 and distributed cache system 480. Model training cluster 410 includes compute equipment 420A-C and distributed cache system 480 includes cache equipment 425A-C.

Compute equipment 420A-C respectively include training engine 450A-C, and synchronized model 430 divided into data chunks 440A-C. Compute equipment 420A and 420C include model parity data 450. Cache equipment 425A-C respectively include chunks 482A-C. Chunks 482A and 482C respectively include two data chunks selected from data chunks 440A-C and model parity data 450. Chunks 482B include three data chunks selected from data chunks 440A-C. In the examples of FIG. 4, referring to descriptions of FIG. 3 for some elements, compute equipment 420A-C may be similar to GPU servers 310A-B, training engines 450A-C may be similar to GPUs 350A-D, synchronized model state 430 may be similar to synchronized model 395, and cache equipment 425A-C may be similar to cache servers 315A-C.

In one or more embodiments, compute equipment 420A-C are tasked with processing an epoch with various training data being processed (not shown). Training engines 450A-C will perform training computations in parallel. In an implementation, training engines 450A-C begin processing an originally synchronized model state (not shown), with the synchronization having been performed between compute equipment 420A-C. As training engines 450A-C proceed to variously process the training data, the originally synchronized model at state training engines 450A-C is altered in a working model states for each of training engines 450A-C (not shown).

Periodically, during a parallel training process, synchronized model state 430 may be generated by combining the working model states of training engines 450A-B. After propagation of synchronized model state 430 among training engines 450A-C, for reasons including improving fault tolerance, and enabling archival and analysis operations, a checkpoint may be performed whereby synchronized model 430 is duplicated to act as a full backup. Although examples herein discuss a checkpoint operation as copying an entire model, it is to be appreciated that this full copy is non-limiting, and one or more embodiments may be similarly applicable to copying of differential snapshots and checkpoints.

In one or more embodiments, after synchronization between compute equipment 420A-C, one or more of compute equipment 420A-C may perform a data chunking operation on a local version of data corresponding to synchronized model state 430, resulting in data chunks 440A-C depicted below respective synchronized model states 430. One or more embodiments may utilize data chunks 440A-C to enable operations including, parallel processing, improving efficiency of the checkpoint operation, improving the efficiency of data transmission across a network, reducing inefficiencies due to process dependency and resource contention among model training cluster 410 and distributed cache system 480.

In addition to reducing the inefficiencies described herein, one or more embodiments may improve the fault-tolerance of the model training process. Specifically, by utilizing distributed cache system 480 operating via separate cache equipment 425A-C, multiple computer systems may be used to store checkpoint data. To augment the improvements in fault-tolerance of distributed cache storage at cache equipment 425A-C, one or more embodiments may generate recovery data 450 from data chunks 440A-C.

Once recovery data 450 and data chunks 440A-C are generated from synchronized model state 430, one or more embodiments may complete the checkpoint operation on the entire model by storing recovery data 450 and data chunks 440A-C in storage nodes of distributed cache system 480.

One or more embodiments may implement checkpoint operations that use data parallelism by using a combination of compute equipment 420A-C to store recovery data 450 and data chunks 440A-C as illustrated in FIG. 14. As illustrated, instead of having one or more of compute equipment 420A-C copy all of recovery data 450 and data chunks 440A-C, compute equipment 420A-C are each depicted as storing a subset of data chunks 440A-C to different combinations of cache equipment 425A-C, e.g., compute equipment 420A copies data chunks 440A-B respectively to cache equipment 425A-B, compute equipment 420B copies data chunk 440B to cache equipment 425B, and compute equipment 420C copies data chunks 440A and 440C respectively to cache equipment 425B-C. In addition, recovery data 450 is copied to cache equipment 425A and 420C respectively. In some implementations, to ensure that at least one (and preferably more) of each of data chunks 440A-C and recovery data 450 are stored to distributed cache system 480, a coordination of the division of data chunk copy among nodes may be implemented. For example, the arrangement depicted in FIG. 4 may have been designated to each of compute equipment 420A-C before commencement of the checkpointing operation. Alternatively, as described below, real time monitoring of performance metrics by embodiments may identify the condition of compute equipment 420B, and the allocation of data chunk copying (or other operations) may be selectively altered to reduce the significance of the condition on the operation of the system.

It is to be appreciated that one or more embodiments depicted in FIG. 4 have stored all of data chunks 440A-C on at least two of cache equipment 425A-C. Even without recovery data 450, this arrangement of data chunks facilitates the recovery of synchronized model state 430 if any one of cache equipment 425A-C (or both of cache equipment 425A and 420C) fails. To facilitate additional fault tolerance, one or more embodiments stores recovery data 450 on cache equipment 425A and 420C. Based on an implementation of recovery data 450, in this arrangement, any two of cache equipment 425A-C could fail, and data chunks 440A-C could be recovered. One or more embodiments may receive a recovery command and use a combination of available recovery data 450 and data chunks 440A-C to recover the stored checkpoint data.

The following section describes different improvements in efficiency that may be enabled by the embodiments described with FIG. 4. In an example, synchronization may take longer to complete at compute equipment 420B than at compute equipment 420A and 420C, e.g., due to hardware differences, resource contention, throughput delays, etc. This lagging of compute equipment 420B may have been identified, for example, by comparing the time it took compute equipment 420B to complete previous synchronizations with time used by compute equipment 420A and 420C.

When this type, or a similar type of difference between compute equipment is identified (e.g., either by being designated ahead of time, or discovered based on real time performance metrics as described above), one or more embodiments may adjust processes to reduce inefficiencies caused by process dependencies (also termed bottlenecks herein). As described herein, if synchronization must be completed before the commencement of the storing of the data chunks 440A-C, e.g., lagging compute node 420B may cause an inefficiency in the operation of the system.

One or more embodiments may reduce this and similar inefficiencies by changing, in real time, the operations that are allocated to compute node 420B. In this example, the specification or requirement that synchronization be completed by compute node 420B before checkpoint storage begins may be eliminated, e.g., as long as compute node 420B has synchronized model state 430 before training recommences, the process may be successful.

Alternatively, in embodiments, during the checkpointing process, the amount of data copying that is allocated to the lagging device may be reduced, e.g., because all three nodes are copying selected parts of the same checkpoint data, compute node 420B may allocated fewer parts to copy. Thus, in the example depicted in FIG. 4, both compute equipment 420A and 420C are tasked with copying, to distributed cache system 480, a data chunk (440A and 440C, respectively), as well as recovery data 450, while compute equipment 420B is only tasked with copying data chunk 440B to distributed cache system 480.

Based on this differential checkpoint operation tasking, one or more embodiments may reduce bottlenecks associated with dependencies across different elements of the system. In this example, a bottleneck was potentially avoided in operations that include, the model synchronization operation, the completion of the storage of data chunks 440A-C and recovery data 450 to distributed cache system 480. Without the adjustments described herein, for both of these operations, the completion of the checkpoint operation might have been delayed, along with the restarting of the training operations.

In another example of differential task assignment across compute equipment 420A-C, in some circumstances, when a performance issue is identified at a compute equipment, other related operations to be performed by the compute equipment may be adjusted. Continuing the example of lagging compute equipment 420B, to reduce the processing load on compute equipment 420B, parity component 424B of compute equipment 420B may not be tasked with generating recovery data 450, e.g., this generation of recovery data 450 being performed by parity components 424A and 424C of compute equipment 420A and 420C, respectively. Also, in this example, because compute equipment 420B was not tasked with storing recovery data 450, one or more embodiments may inhibit the generation of the recovery data by compute equipment 420B.

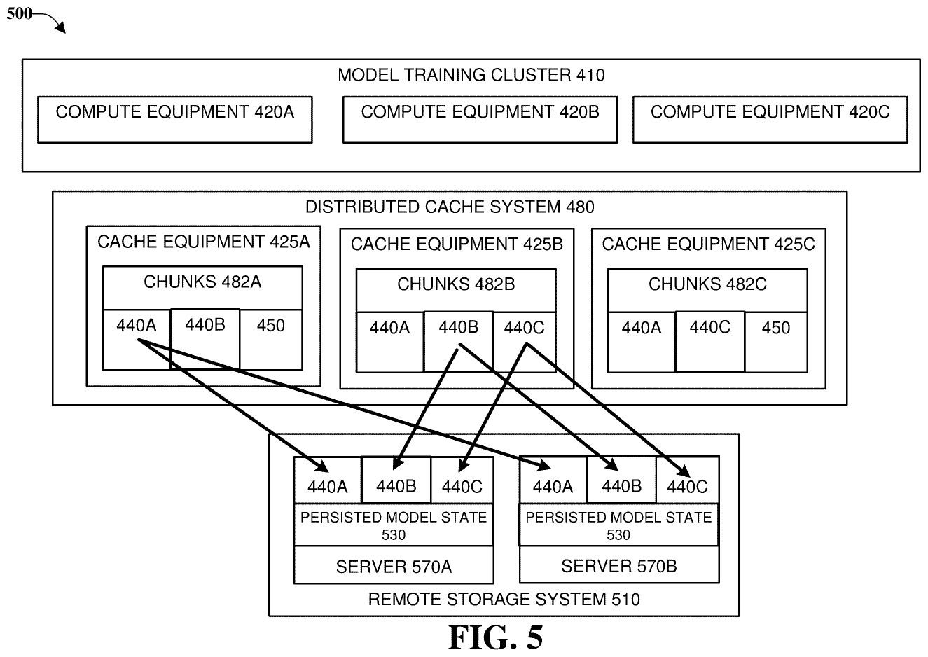

FIG. 5 is an architecture diagram of an example system 500 that can facilitate persisting the checkpoint data stored in the distributed cache system, in accordance with one or more embodiments. For purposes of brevity, description of like elements and/or processes employed in other embodiments is omitted.

As depicted, system 500 includes model training cluster 410, distributed cache system 480, and remote storage system 510. Model training cluster 410 includes compute equipment 420A-C and distributed cache system 480 includes cache equipment 425A-C. Remote storage system is connected to distributed cache system 480, and includes servers 570A-B.

At this point in the process, one or more embodiments have completed the storage of the fault tolerant checkpoint data in distributed cache system 480. In some implementations, the fault tolerance protocol used by embodiments to protect the checkpoint data employs elements of data redundancy and the use of generated recovery data. For example, data chunks 440A-C are stored with data redundancy and generated recovery data.

Continuing the discussion of an example checkpoint storage process employed by some embodiments, at periodic intervals distributed cache system 480 may use one or more of cache equipment 425A-C to persist data chunks 440A-C to servers 570A-B of remote storage system 510, resulting in persisted model state 530 being stored with data redundancy elements.

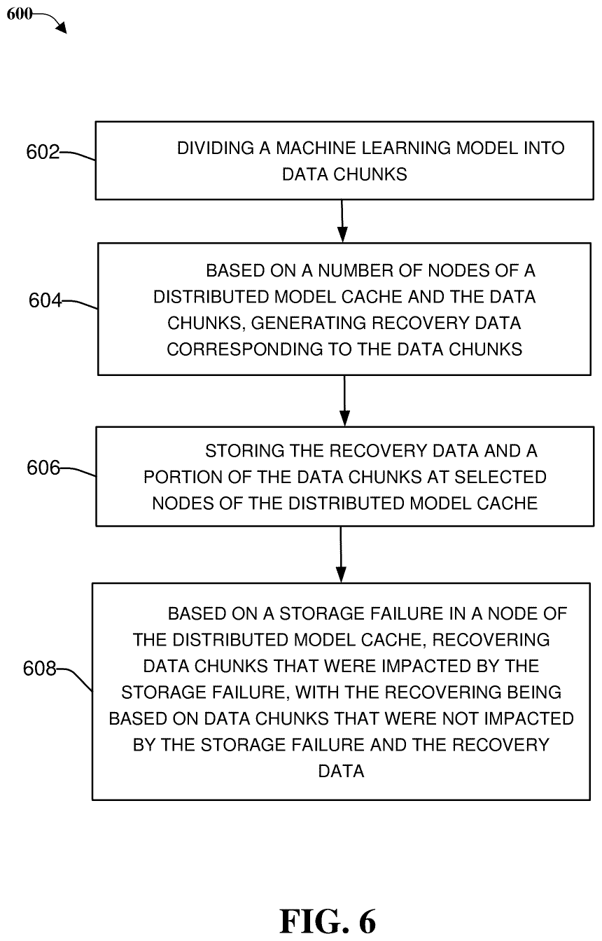

FIG. 6 depicts a flow diagram representing example operations of an example method 600 that can facilitate storing fault tolerant checkpoint data in a distributed cache system, in accordance with one or more embodiments. For purposes of brevity, description of like elements and/or processes employed in other embodiments is omitted.

In some examples, one or more embodiments of method 600 can be implemented by chunking component 122, parity component 124, caching component 126, recovery component 128, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, chunking component 122 of compute equipment 150 can, in one or more embodiments, divide a machine learning model into data chunks. At 604 of method 600, parity component 124 of compute equipment 150 can, in one or more embodiments, based on a number of nodes of a distributed model cache and the data chunks, generate recovery data corresponding to the data chunks. At 606 of method 600, caching component 126 of compute equipment 150 can, in one or more embodiments, store recovery data and a portion of the data chunks at selected nodes of the distributed model cache. At 608 of method 600, recovery component 128 of compute equipment 150 can, in one or more embodiments, based on a storage failure in a node of the distributed model cache, recover data chunks that were impacted by the storage failure, with the recovering being based on data chunks that were not impacted by the storage failure and the recovery data.

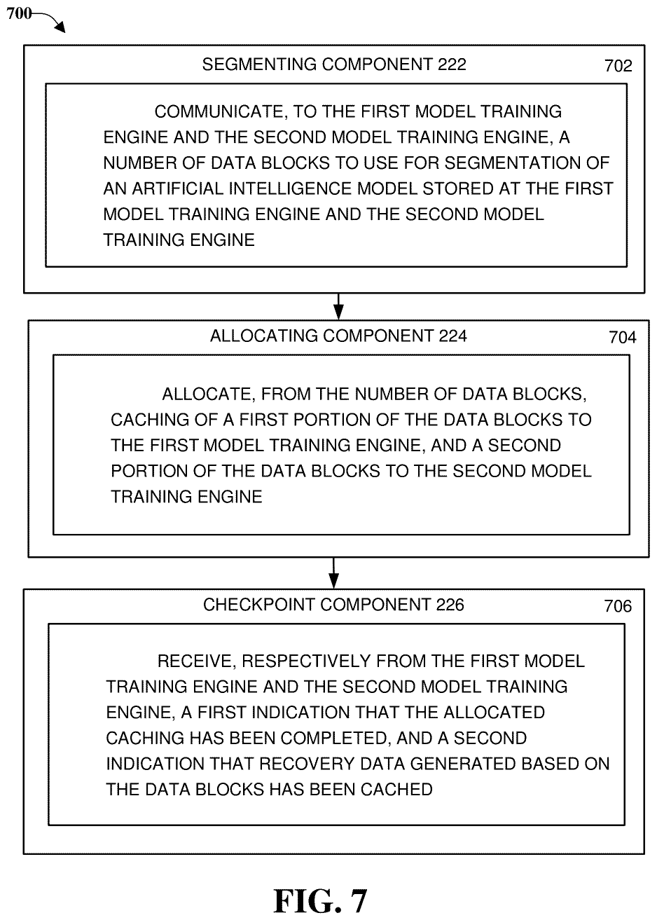

FIG. 7 depicts an example system 700 that can facilitate storing fault tolerant checkpoint data in a distributed cache system, in accordance with one or more embodiments. For purposes of brevity, description of like elements and/or processes employed in other embodiments is omitted.

Example system 700 can include segmenting component 222, allocating component 224, checkpoint component 226, and other components that can be used to implement aspects of system 700, as described herein, in accordance with one or more embodiments.

At 702 of FIG. 7, segmenting component 222 can communicate, to the first model training engine and the second model training engine, a number of data blocks to use for segmentation of an artificial intelligence model stored at the first model training engine and the second model training engine.

At 704 of FIG. 7, allocating component 224 can allocate, from the number of data blocks, caching of a first portion of the data blocks to the first model training engine, and caching of a second portion of the data blocks to the second model training engine.

At 706 of FIG. 7, checkpoint component 226 can receive, respectively from the first model training engine and the second model training engine, a first indication that the allocated caching has been completed, and a second indication that recovery data generated based on the data blocks has been cached.

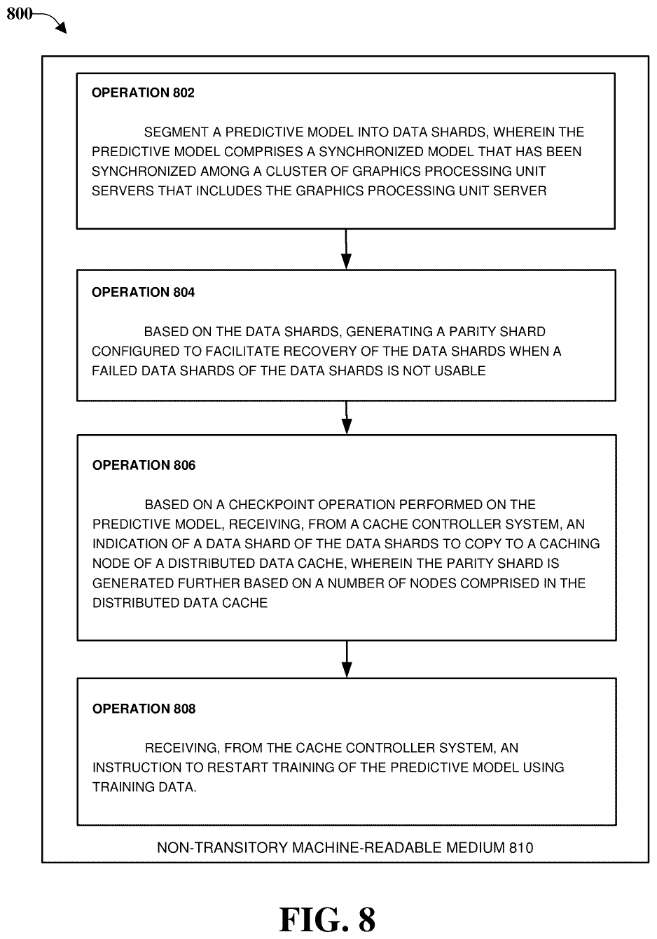

FIG. 8 depicts an example 800 non-transitory machine-readable medium 810 that can include executable instructions that, when executed by a processor of a system, can facilitate storing fault tolerant checkpoint data in a distributed cache system, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which includes segmenting a predictive model into data shards, wherein the predictive model comprises a synchronized model that has been synchronized among a cluster of graphics processing unit servers that includes the graphics processing unit server.

Operation 804 includes, based on the data shards, generating a parity shard configured to facilitate recovery of the data shards when a failed data shards of the data shards is not usable. Operation 806 includes, based on a checkpoint operation performed on the predictive model, receiving, from a cache controller system, an indication of a data shard of the data shards to copy to a caching node of a distributed data cache, wherein the parity shard is generated further based on a number of nodes comprised in the distributed data cache. Operation 808 includes receiving, from the cache controller system, an instruction to restart training of the predictive model using training data.

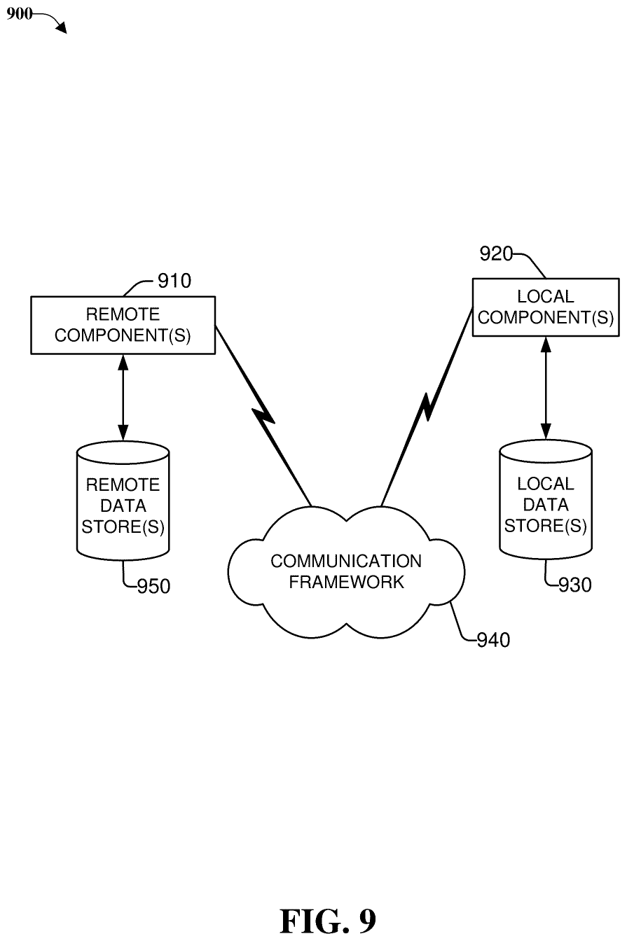

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2(3GPP 2 ) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
dividing, by a system comprising a processor, a machine learning model into data chunks;
based on a number of nodes of a distributed model cache and the data chunks, generating, by the system, recovery data corresponding to the data chunks;
storing, by the system, the recovery data and a portion of the data chunks at selected nodes of the distributed model cache; and
based on a storage failure in a node of the distributed model cache, recovering, by the system, data chunks that were impacted by the storage failure, wherein the recovering is based on data chunks that were not impacted by the storage failure and the recovery data.

2. The method of claim 1, wherein the system comprises a model training system working in parallel with another model training system configured to store another portion of the data chunks at the distributed model cache.

3. The method of claim 2, wherein the portion of the data chunks and the other portion of the data chunks, in combination, comprise all of the data chunks of the machine learning model.

4. The method of claim 3, wherein the portion and the other portion were selected by a coordination between the model training system and the other model training system.

5. The method of claim 2, wherein a completion of the storing of the data chunks and the recovery data by the model training system and the other model training system comprises completion of a checkpoint operation for the machine learning model.

6. The method of claim 2, wherein the machine learning model comprises a synchronized machine learning model that was synchronized between the model training system and the other model training system before the dividing of the machine learning model.

7. The method of claim 6, wherein the model training system comprises a training compute device that trained the machine learning model before the synchronizing of the machine learning model.

8. The method of claim 7, further comprising:
receiving, by the system, an indication of a completion of the storing of the recovery data and the data chunks at the selected nodes of the distributed model cache; and
based on the indication, restarting, by the system, training of the machine learning model.

9. The method of claim 1, wherein the recovery data comprises recovery data generated in accordance with a fault-tolerance protocol.

10. The method of claim 9, wherein the fault-tolerance protocol comprises an erasure coding protocol.

11. The method of claim 9, wherein the number of nodes of the distributed model cache was selected based on the fault-tolerance protocol.

12. A system, comprising:
at least one memory that stores computer executable instructions; and
at least one processor configured to process the computer executable instructions that, when executed by the at least one processor, facilitate performance of operations, comprising:
communicating, to the first model training engine and the second model training engine, a number of data blocks to use for segmentation of an artificial intelligence model stored at the first model training engine and the second model training engine,
allocating, from the number of data blocks, caching of:
a first portion of the data blocks to the first model training engine, and
a second portion of the data blocks to the second model training engine, and
receiving, respectively from the first model training engine and the second model training engine:
a first indication that the allocated caching has been completed, and
a second indication that recovery data generated based on the data blocks has been cached.

13. The system of claim 12, wherein the operations further comprise:
receiving, from a requesting system, a request for recovery of the data blocks based on an unreadable data block of the data blocks;
based on recoverable ones of the data blocks and the recovery data, generating a replacement data block to replace the unreadable data block; and
communicating the replacement data block to the requesting system.

14. The system of claim 12, wherein the artificial intelligence model comprises a synchronized artificial intelligence model generated by combining a first working model trained by the first model training engine with a second working model trained by the second model training engine.

15. The system of claim 12, wherein the operations further comprise:
identifying that the first model training engine has a performance characteristic that differs from the performance characteristic of the second model training engine; and
based on the identifying, determining a first size of the first portion that differs from a second size of the second portion, wherein the first size was selected to reduce an inefficiency predicted to be caused by the performance characteristic.

16. The system of claim 15, wherein the performance characteristic comprises a time to complete the caching of the respective first portion and second portion, and wherein, the determining of the first size comprises determining the first size so as to reduce performance differences between the first model training engine and the second model training engine.

17. The system of claim 12, wherein the first portion and the second portion are cached to a distributed data cache, and wherein the operations further comprise:
receiving, from the distributed data cache, an indication that the data chunks have been further stored in a persistent storage device.

18. A non-transitory machine-readable medium comprising executable instructions that, when executed by at least one processor of a graphics processing unit server, facilitate performance of operations, the operations comprising:
segmenting a predictive model into data shards, wherein the predictive model comprises a synchronized model that has been synchronized among a cluster of graphics processing unit servers that includes the graphics processing unit server;
based on the data shards, generating a parity shard configured to facilitate recovery of the data shards when a failed data shards of the data shards is not usable;
based on a checkpoint operation performed on the predictive model, receiving, from a cache controller system, an indication of a data shard of the data shards to copy to a caching node of a distributed data cache, wherein the parity shard is generated further based on a number of nodes comprised in the distributed data cache;
receiving, from the cache controller system, an instruction to restart training of the predictive model using training data.

19. The non-transitory machine-readable medium of claim 18, wherein the instruction was received based on a completion of the checkpoint operation to the distributed data cache by the graphics processing unit servers of the graphics processing unit cluster.

20. The non-transitory machine-readable medium of claim 18, wherein the operations further comprise, receiving, from the cache controller system, a recovered version of the predictive model at a state that was subject to the checkpoint operation, and wherein the recovered version of the predictive model was recovered based on the parity shard.
